(19) United States
(12) Patent Application Publication
(10) Pub. No.: US 2020/0104442 A1
(43) Pub. Date: Apr. 2, 2020

(54) METHOD OF MODLING MANY PARTICLE SYSTEMS

(71) Applicant: Purdue Research Foundation, West Lafayette, IN (US)

(72) Inventors: Tillmann C. Kubis, West Lafayette, IN (US); James Anthony Charles, West Lafayette, IN (US); Daniel Alberto Lemus, West Lafayette, IN (US)

(73) Assignee: Purdue Research Foundation, West Lafayette, IN (US)

(21) Appl. No.: 16/588,046

(22) Filed: Sep. 30, 2019

Related U.S. Application Data
(60) Provisional application No. 62/738,730, filed on Sep. 28, 2018.

(51) Int. Cl. G06F 17/50

(52) U.S. Cl. CPC G06F 17/5018; G06F 2217/16

(57) ABSTRACT

A non-transitory machine readable storage medium having a machine readable program stored therein, wherein the machine readable program, when executed on a processing system, causes the processing system to perform a procedure of modeling many particle systems, wherein the procedure includes discretizing a many particle system into a first set of basis functions, thereby producing a discretized many particle system, wherein the first set of basis functions comprises a plurality of basis functions. The procedure further includes extracting a plurality of observables in the many particle system represented in the first set of basis functions by applying a respective operator on a corresponding Green's function of the plurality of Green's functions.

### CROSS-REFERENCE TO RELATED APPLICATIONS

The present U.S. patent application is related to and claims the priority benefit of U.S. Provisional Patent Application Ser. No. 62/738,730, filed Sep. 28, 2018, the contents of which is hereby incorporated by reference in its entirety into this disclosure.

### BACKGROUND

This section introduces aspects that may help facilitate a better understanding of the disclosure. Accordingly, these statements are to be read in this light and are not to be understood as admissions about what is or is not prior art.

Numerical load to solve Nonequilibrium Green's Functions (NEGF) that represent many particle systems typically requires a recursive solution method. The many particle system is partitioned into segments. The NEGF equations are then solved on each segment individually, instead of on the total system. This limits the peak numerical load to the size of the largest segment, but particle-particle correlations that extend beyond the limits of a single segment or a few segments are not solved in the above procedure. Additionally, important physical information is lost as well. Long-range interactions, such as many charge-based forces, end up being incompletely considered. Moreover, conventional methodologies are extremely computationally extensive.

### SUMMARY

One aspect of the present application relates to a non-transitory machine readable storage medium having a machine readable program stored therein, wherein the machine readable program, when executed on a processing system, causes the processing system to perform a procedure of modeling many particle systems, wherein the procedure includes discretizing a many particle system into a first set of basis functions, thereby producing a discretized many particle system, wherein the first set of basis functions comprises a plurality of basis functions. The procedure additionally includes partitioning the discretized many particle system into a plurality of subsystems. Each subsystem of the plurality of subsystems is connected with at most two other subsystems of the plurality of subsystems. Each basis function of the plurality of basis functions correspond to a respective subsystem of the plurality of subsystems of the discretized many particle system. Additionally, the procedure includes determining a second set of basis functions for each subsystem of the plurality of subsystems, wherein the second set of basis functions includes a plurality of functions, wherein each function of the plurality of functions describes an aspect of the many particle system, wherein the second set of basis functions is user defined.

Moreover, the procedure includes transforming, for at least a subsystem of the plurality of subsystems, at least a portion of a discretized non-equilibrium Green's function method into the second set of basis functions, thereby producing a user-defined rank discretized nonequilibrium Green's function method. Further, the procedure includes solving the user-defined rank discretized non-equilibrium Green's function method with a generalized recursive Green's function method, thereby producing a plurality of Green's functions. Moreover, the procedure includes transforming at least a portion of the plurality of Green's functions into the first set of basis functions. The procedure further includes extracting a plurality of observables in the many particle system represented in the first set of basis functions by applying a respective operator on a corresponding Green's function of the plurality of Green's functions.

Nonequilibrium Green's functions (NEGF) can predict the quantum transport properties in many particle systems (such as electrons or phonons in semiconductor nanodevice). Green's functions handle coherent quantum effects such as interferences, tunneling and confinement as well as incoherent effects such as scattering with device imperfections and lattice vibrations on equal footing. Whenever many particle systems are discretized to be solved with NEGF on a computer, a first critical step is the choice of the set of basis functions that host the discretization. A proper choice of that set defines 1) the amount of detail to which the physics is covered and 2) the numerical complexity of the discretized system.

The presented application combines these two aspects: it allows to choose basis sets for different device areas and solve the system in segments. In contrast to existing methods, it allows to solve arbitrary long ranged particle-particle correlations. In this way, all many particle physics can be modeled accurately well below the limits of state-of-the-art hardware.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. It is emphasized that, in accordance with standard practice in the industry, various features may not be drawn to scale and are used for illustration purposes only. In fact, the dimensions of the various features in the drawings may be arbitrarily increased or reduced for clarity of discussion.

FIG. 1 illustrates a schematic of a simulated TFET device.

FIG. 2 illustrates current-voltage characteristics of the TFET device.

FIG. 3 illustrates comparison of subthreshold slope for ballistic and scattering cases.

FIG. 4 illustrates ballistic energy resolved current density at OFF state along with the potential profile.

FIG. 5 illustrates energy resolved current density at OFF state along with the potential profile in the presence of non-local POP scattering.

FIG. 6 illustrates ballistic energy resolved current density at ON state along with the potential profile.

FIG. 7 illustrates energy resolved current density at ON state along with the potential profile in the presence of non-local POP scattering.

FIG. 8 illustrates cut section of energy resolved current density at x=5 nm.

FIG. 9 illustrates cut section of energy resolved current density at x=20 nm.

FIG. 10 illustrates one example of a computing or processing node 1500 for operating a method or a software architecture in accordance with the present application.

### DETAILED DESCRIPTION

The following disclosure provides many different embodiments, or examples, for implementing different features of the present application. Specific examples of components and arrangements are described below to simplify the present disclosure. These are examples and are not intended to be limiting. The making and using of illustrative embodiments are discussed in detail below. It should be appreciated, however, that the disclosure provides many applicable concepts that can be embodied in a wide variety of specific contexts. In at least some embodiments, one or more embodiment(s) detailed herein and/or variations thereof are combinable with one or more embodiment(s) herein and/or variations thereof.

A non-transitory machine readable storage medium having a machine readable program stored therein, wherein the machine readable program, when executed on a processing system, causes the processing system to perform a procedure of modeling many particle systems, wherein the procedure includes discretizing a many particle system into a first set of basis functions, thereby producing a discretized many particle system, wherein the first set of basis functions includes a plurality of basis functions. The procedure additionally includes partitioning the discretized many particle system into a plurality of subsystems. Each subsystem of the plurality of subsystems is connected with at most two other subsystems of the plurality of subsystems. Each basis function of the plurality of basis functions correspond to a respective subsystem of the plurality of subsystems of the discretized many particle system. Additionally, the procedure includes determining a second set of basis functions for each subsystem of the plurality of subsystems, wherein the second set of basis functions comprises a plurality of functions, wherein each function of the plurality of functions describes an aspect of the many particle system, wherein the second set of basis functions is user defined.

Moreover, the procedure includes transforming, for at least a subsystem of the plurality of subsystems, at least a portion of a discretized non-equilibrium Green's function method into the second set of basis functions, thereby producing a user-defined rank discretized nonequilibrium Green's function method. Further, the procedure includes solving the user-defined rank discretized non-equilibrium Green's function method with a generalized recursive Green's function method, thereby producing a plurality of Green's functions. Moreover, the procedure includes transforming at least a portion of the plurality of Green's functions into the first set of basis functions. The procedure further includes extracting a plurality of observables in the many particle system represented in the first set of basis functions by applying a respective operator on a corresponding Green's function of the plurality of Green's functions.

the discretizing the many particle system into the first set of basis functions includes at least one of: using an envelope function approximation method; using an effective mass approximation method; using a k.p method; using an atomistic tight binding method; using a density functional theory method; using a finite differences discretization method; using a finite element method; using a cellular automata method; using a pseudo-potential method; using a molecular orbital method; using an atomic orbital method; or using a muffin-tin orbital method.

In one or more embodiments, the many particle system includes at least one of electrons, photons, protons, spinons, skyrmions, polarons, polaritons, atoms, Cooper pairs, Bloch waves, magnons, plasmons, anyons, Fermions, Bosons, mesons, or Baryons.

The determining a second set of basis functions includes at least one of: using eigenfunctions of portions of the many particle system; using approximations to a band structure of portions of the many particle system; using a subset of the first set of basis functions; using Bloch functions of portions of the many particle system; using Wannier functions of portions of the many particle systems; using Wannier-Stark functions of portions of the many particle systems; or using Airy functions of portions of the many particle systems. And the portions include at least one of a diagonal, a submatrix of a discretized many particle system, a set of sub-matrices of the discretized many particle system, or an approximate of the discretized many particle system.

The aspect of the many particle system includes at least one of local properties of sections of the many particle system, local material properties of sections of the many particle system, quantum confinement of sections of the many particle system, quantum states of sections of the many particle system, charge density of sections of the many particle system, particle density of sections of the many particle system, heat density of sections of the many particle system, spin density of sections of the many particle system, color charge density of sections of the many particle system, chirality density of sections of the many particle system, current density of sections of the many particle system, particle current density of sections of the many particle system, heat current density of sections of the many particle system, spin current density of sections of the many particle system, chirality current density of sections of the many particle system, interaction strength of sections of the many particle system, or color current density of sections of the many particle system. And the sections include an entirety of the many particle system.

The transforming at least the portion of the discretized non-equilibrium Green's function method into the second set of basis functions includes at least one of transforming the discretized non-equilibrium Green's function method into the second set of basis functions from the first set of basis functions; or transforming an entirety of the discretized non-equilibrium Green's function method into the second set of basis functions.

The solving the user-defined rank discretized non-equilibrium Green's function method includes at least one of solving using a recursive Green's function method; solving using a Keldysh method; solving using a Dyson method; solving using a LDL decomposition method; or solving using a singular value decomposition method.

The transforming at least the portion of the plurality of Green's functions into the first set of basis functions includes at least one of: transforming the discretized non-equilibrium Green's function method into the first set of basis functions from the second set of basis functions; or transforming an entirety of the discretized non-equilibrium Green's function method into the first set of basis functions.

The respective operator from the above procedure includes at least one of a density operator, a current density operator, a susceptibility operator, a polarization operator, a density of states operator, a position operator, a projection operator, or an integration operator.

The recursive Green's function algorithm foots on a block LDL^{T} decomposition:

$${( {G}^{R} )}^{- 1} = {LDL}^{T} = ( \begin{matrix}⋱ & ⋱ & ⋱ & & \\ ⋱ & 1 & 0 & 0 & \\ ⋱ & {L}_{q - 1 , q - 2} & 1 & 0 & ⋱ \\ & 0 & {L}_{q , q - 1} & 1 & ⋱ \\ & & ⋱ & ⋱ & ⋱\end{matrix} ) ( \begin{matrix}⋱ & ⋱ & & & \\ ⋱ & {D}_{q - 1 , q - 1} & 0 & & \\ & 0 & {D}_{q , q} & 0 & \\ & & 0 & {D}_{q + 1 , q + 1} & ⋱ \\ & & ⋱ & ⋱ & ⋱\end{matrix} ) ( \begin{matrix}⋱ & ⋱ & ⋱ & & \\ ⋱ & 1 & {( {L}_{q - 1 , q - 2} )}^{T} & 0 & \\ & 0 & 1 & {( {L}_{q , q - 1} )}^{T} & ⋱ \\ & & 0 & 1 & ⋱ \\ & & & ⋱ & ⋱\end{matrix} ) , \qquad ( 2 )$$

with ^{T} denoting the transpose of a matrix. The generator functions of the last equation are given by

D_{q,q}=(G^{R})_{q,q}⁻¹−Σₖ₌₀^{q-1}L_{q,k}D_{k,k}(L_{q,k})^{T}, (3)

L_{q,j}=[(G^{R})_{q,j}⁻¹−Σₖ₌₀^{j-1}L_{q,k}D_{k,k}(L_{j,k})^{T}]D_{j,j}⁻¹. (4)

It is worth the mention the result in the case of a tri-diagonal G^{R-1} (e.g. in a ballistic 1st nearest neighbor tight binding situation)

G_{q,q}^{R}=(G^{R})_{q,q}⁻¹−L_{q,q-1}D_{q-1,q-1}(L_{q,q-1})^{T}, (5)

L_{q,q-1}=(G^{R})_{q,q-1}⁻¹D_{q-1,q-1}⁻¹. (6)

The recursive Green's function is based off of two separate steps: the first step is the forward recursive Green's function where the algorithm starts from the left hand side of the device connected to the left lead. The algorithm is then calculated recursively, marching through the device towards the right hand side. Once the algorithm reaches the right hand side of the device and connects to the right lead, the backward step is then conducted to get the exact Green's functions. Details of both of these steps are below. The goal is to solve the so-called left connected forward recursive Green's functions g^{R}and g^{<}.

Standard Tridiagonal forward g^{R}: we can deduce the standard tridiagonal forward RGF formula from Eqs. (5) and (6). The diagonal blocks of the inverse forward retarded Green's function (g^{R})⁻¹ contain only the energy E, the diagonal block Hamiltonian H and the scattering self-energy Σ^{R}

g_{q,q}^{R}=E−H_{q,q}−Σ_{q,q}^{R}−H_{q,q-1}g_{q-1,q-1}^{R}H_{q-1,q}(tridiagonal). (7)

Note that the initial block of (g^{R})⁻¹ also contains a contact self-energy.

Nonlocal scattering in g^{R}: In the following the Eq. (4) is applied on the forward retarded Green's function (i.e. D=(g^{R})⁻¹). In order to avoid terms with (g^{R})⁻¹ in the formula for (g^{R})⁻¹, we substitute Eq. (4) into Eq. (3)

$${( {g}_{q , q}^{R} )}^{- 1} = {( {G}^{R} )}_{q , q}^{- 1} - {\sum }_{k = q - 1 - N}^{q - 1} [ {( {G}^{R} )}_{q , k}^{- 1} - {\sum }_{{k}^{′} = k - 1 - N}^{k - 1} {{L}_{q , {k}^{′}} ( {g}_{{k}^{′} , {k}^{′}}^{R} )}^{- 1} {( {L}_{k , {k}^{′}} )}^{T} ] {{g}_{k , k}^{R} ( {g}_{k , k}^{R} )}^{- 1} \times {\{ [ {( {G}^{R} )}_{q , k}^{- 1} - {\sum }_{{k}^{′} = 0}^{k - 1} {{L}_{q , {k}^{′}} ( {g}_{{k}^{′} , {k}^{′}}^{R} )}^{- 1} {( {L}_{k , {k}^{′}} )}^{T} ] {g}_{k , k}^{R} \}}^{T} = {( {G}^{R} )}_{q , q}^{- 1} - {\sum }_{k = q - 1 - N}^{q - 1} [ {( {G}^{R} )}_{q , k}^{- 1} - {\sum }_{{k}^{′} = k - 1 - N}^{k - 1} {{L}_{q , {k}^{′}} ( {g}_{{k}^{′} , {k}^{′}}^{R} )}^{- 1} {( {L}_{k , {k}^{′}} )}^{T} ] {( {g}_{k , k}^{R} )}^{T} \times {[ {( {G}^{R} )}_{q , k}^{- 1} - {\sum }_{{k}^{′} = k - 1 - N}^{k - 1} {{L}_{q , {k}^{′}} ( {g}_{{k}^{′} , {k}^{′}}^{R} )}^{- 1} {( {L}_{k , {k}^{′}} )}^{T} ]}^{T} . \qquad ( 8 )$$

Here, N is the number of rows of offdiagonal blocks of (G^{R})⁻¹. Note that the inverse (g_{0,0}^{R})⁻¹ is given by construction

(g_{0,0}^{R})⁻¹=(G^{R})_{0,0}⁻¹=E−H_{0,0}−Σ_{0,0}^{R}. (9)

For the q=1 case, the equation holds

(g_{1,1}^{R})⁻¹=(G^{R})_{1,1}⁻¹−(G^{R})_{1,0}⁻¹g_{0,0}^{R}[(G^{R})_{1,0}⁻¹]^{T}

L_{1,0}=(G^{R})_{1,0}⁻¹g_{0,0}^{R}. (10)

For the q=2 case, the equation holds

(g_{2,2}^{R})⁻¹=(G^{R})_{2,2}⁻¹−[(G^{R})_{2,0}⁻¹](g_{0,0}^{R})^{T}[(G^{R})_{2,0}⁻¹]^{T}

−[(G^{R})_{2,1}⁻¹−L_{2,0}(g_{0,0}^{R})⁻¹(L_{1,0})^{T}](g_{1,1}^{R})^{T}

×[(G^{R})_{2,1}⁻¹L_{2,0}(g_{0,0}^{R})⁻¹(L_{1,0})^{T}]^{T} (11)

L_{2,0}=(G^{R})_{2,0}⁻¹g_{0,0}^{R} (12)

Substituting the L_{1,0} and L_{2,0} into the (g_{2,2}^{R})⁻¹ gives

$${( {g}_{2 , 2}^{R} )}^{- 1} = {( {G}^{R} )}_{2 , 2}^{- 1} - {( {G}^{R} )}_{2 , 0}^{- 1} {{( {g}_{0 , 0}^{R} )}^{T} [ {( {G}^{R} )}_{2 , 0}^{- 1} ]}^{T} - [ {( {G}^{R} )}_{2 , 1}^{- 1} - {( {G}^{R} )}_{2 , 0}^{- 1} {g}_{0 , 0}^{R} {{D}_{0 , 0} ( {( {G}^{R} )}_{1 , 0}^{- 1} {g}_{0 , 0}^{R} )}^{T} ] {( {g}_{1 , 1}^{R} )}^{T} \times {[ {( {G}^{R} )}_{2 , 1}^{- 1} - {( {G}^{R} )}_{2 , 0}^{- 1} {g}_{0 , 0}^{R} {{D}_{0 , 0} ( {( {G}^{R} )}_{1 , 0}^{- 1} {g}_{0 , 0}^{R} )}^{T} ]}^{T} = {( {G}^{R} )}_{2 , 2}^{- 1} - [ {( {G}^{R} )}_{2 , 0}^{- 1} ] {{( {g}_{0 , 0}^{R} )}^{T} [ {( {G}^{R} )}_{2 , 0}^{- 1} ]}^{T} - \{ {( {G}^{R} )}_{2 , 1}^{- 1} - {( {G}^{R} )}_{2 , 0}^{- 1} {{( {g}_{0 , 0}^{R} )}^{T} [ {( {G}^{R} )}_{1 , 0}^{- 1} ]}^{T} \} {( {g}_{1 , 1}^{R} )}^{T} \times \{ {( {G}^{R} )}_{2 , 1}^{- 1} - {( {G}^{R} )}_{2 , 0}^{- 1} {{( {g}_{0 , 0}^{R} )}^{T} [ {( {G}^{R} )}_{1 , 0}^{- 1} ]}^{T} \} . \qquad ( 13 )$$

We simplify this equation further using (g_{0,0}^{R})^{T}=g_{0,0}^{R}

(g_{2,2}^{R})⁻¹

=(G^{R})_{2,2}⁻¹−[(G^{R})_{2,0}⁻¹]g_{0,0}^{R}[(G^{R})_{2,0}⁻¹]^{T}

−{(G^{R})_{2,1}⁻¹−(G^{R})_{2,0}⁻¹g_{0,0}^{R}[(G^{R})_{1,0}⁻¹]^{T}}g_{1,1}^{R}

×{(G^{R})_{2,1}⁻¹−(G^{R})_{2,0}⁻¹g_{0,0}^{R}[(G^{R})_{1,0}⁻¹]^{T}}. (14)

To ease the coming equations, we define

\tilde{L}_{q,k}≡(G^{R})_{q,k}⁻¹−Σ_{k′=q-1-N}^{k-1}\tilde{L}_{q,k′}g_{k′,k′}^{R}(\tilde{L}_{k,k′})^{T}, (15)

which gives for the forward retarded Green's function g^{R}

g_{q,q}^{R}=[(G^{R})_{q,q}⁻¹−Σ_{k=q-1-N}^{q-1}\tilde{L}_{q,k}g_{k,k}^{R}(\tilde{L}_{q,k})^{T}]⁻¹. (16)

We note that in literature some variables for the diagonal blocks of matrix G^{R} are defined extra

$$\begin{matrix}{G}^{R} = {A}^{- 1} , & ( 17 ) \\ {g}^{R 0} = ( \begin{matrix}{( {A}_{1 : q , 1 : q} )}^{- 1} & 0 \\ 0 & {( {A}_{q + 1 , q + 1} )}^{- 1}\end{matrix} ) = ( \begin{matrix}{g}_{1 : q , 1 : q}^{R 0} & 0 \\ 0 & {g}_{q + 1 , q + 1}^{r 0}\end{matrix} ) & ( 18 )\end{matrix}$$

The L_{q,k} and \tilde{L}_{q,k} differ in the inverse of the respective central matrix in the product of the sum and in the extra multiplication of g^{R} in the case of L_{q,k}. This way, however, the (g^{R})⁻¹'s do not depend on (g^{R})⁻¹, but on g^{R} instead. For later reference, we reformulate Eq. (16) using the definition of A and the final result of this section

g_{q,q}^{R}=[A_{q,q}−Σ_{k=q-1-N}^{q-1}\tilde{L}_{q,k}g_{k,k}^{R}(\tilde{L}_{q,k})^{T}]⁻¹, (19)

with

\tilde{L}_{q,k}=A_{q,k}−Σ_{k′=q-1-N}^{k-1}\tilde{L}_{q,k′}g_{k′,k′}^{R}(\tilde{L}_{k,k′})^{T}. (20)

Nonlocal scattering in g^{<}1: Using the LDL^{T} decomposition, the nonlocal g^{R}, and the decomposition

Starting from the LDL^{†} decomposition that was used for g^{R}/G^{R}:

A=(E−H−Σ_{scatt}−Σ_{contact})=LDL^{†} (21)

To avoid extra inversions it is more convenient to use \tilde{L}_{i,j}, where i and j are layer indices. To convert between L_{i,j} and \tilde{L}_{i,j}

\tilde{L}_{i,j}=L_{i,j}g_{j,j}^{R} (22)

The Keldysh equation for g^{<} is

Ag^{<}=Σ^{<}(g^{R})^{†} (23)

LDL^{†}g^{<}=Σ^{<}(g^{R})^{†} (24)

g^{<}=(L⁻¹)^{†}D⁻¹L⁻¹Σ^{<}(g^{R})^{†} (25)

Replace L with −L for below:
off-diagonal g_{i,j}^{<}
with i>j

g_{i,j}^{<}=g_{i,i}^{R}Σₖ₌ᵢ₋ₙⁱ⁻¹\tilde{L}_{i,k}g_{k,j}^{<}+g_{i,i}^{R}Σₖ₌ᵢ₋ₙ^{j-1}Σ_{i,k}^{<}g_{k,j}^{A}+g_{i,i}^{R}Σ_{i,j}^{<}g_{j,j}^{A} (26)

diagonal g_{i,j}^{<}

g_{i,i}^{<}=g_{i,i}^{R}Σₖ₌ᵢ₋ₙⁱ⁻¹ \tilde{L}_{i,k}(−g_{i,k}^{<})^{†}+g_{i,i}^{R} Σₖ₌ᵢ₋ₙⁱ⁻¹Σ_{i,k}^{<}Σₗ₌ₖⁱ⁻¹g_{k,l}^{A}\tilde{L}_{l,i}g_{i,i}^{A}+g_{i,i}^{R}Σ_{i,i}^{<}g_{i,i}^{A} (27)

To get the exact Green's functions, the backward step is used along with the previously calculated g^{R}and g^{<}. The backward recursive Green's function G^{R} in the case of a “standard” tridiagonal (G^{R})⁻¹ reads

G_{q,q}^{R}=g_{q,q}^{R}−g_{q,q}^{R}H_{q,q+1}G_{q+1,q}^{R}(tridiagonal). (28)

Nonlocal scattering in G^{R}: It is plausible that the offdiagonal block of the Hamiltonian matrix H_{q,q+1} gets augmented by all remaining offdiagonal matrix blocks of (G^{R})⁻¹ in a more general situation

G_{q,q}^{R}=g_{q,q}^{R}−g_{q,q}^{R}Σ_{j=q+1}^{q+1+N}\tilde{L}_{q,j}G_{j,q}^{R} (29)

The same plausibility holds for the offdiagonal blocks of G^{R}

G_{q,k}^{R}=−g_{q,q}^{R}Σ_{j=q+1}^{q+1+N}\tilde{L}_{q,j}G_{j,k}^{R} (30)

Nonlocal scattering in G^{<}: The Keldysh equation for G^{<} can be written as:

G^{<}=(I−L^{T})G^{<}+g^{<}(L^{T})^{-†} (31)

Replace L with −L for below:
off-diagonal G_{i,j}^{<}
with i<j

G_{i,j}^{<}=g_{i,j}^{<}+Σₖ₌ᵢ₊₁ⁱ⁺¹⁺ⁿg_{i,k}^{<}L_{k,j}^{†}g_{j,j}^{A}+g_{i,i}^{R} Σₖ₌ᵢ₊₁ⁱ⁺¹⁺ⁿL_{i,k}^{T}G_{k,j}^{<} (32)

diagonal G_{i,j}^{<}

G_{i,i}^{<}=g_{i,j}^{<}+Σₖ₌ᵢ₊₁ⁱ⁺¹⁺ⁿg_{i,k}^{<}L_{k,i}^{†}g_{i,i}^{A}+g_{i,i}^{R} Σₖ₌ᵢ₊₁ⁱ⁺¹⁺ⁿL_{i,k}^{T}G_{k,i}^{<} (33)

But these equations have an issue mainly that they couple far-off diagonal elements. To remove this another recursive relation is found so far not exploited above to give us the final result of this section.

G_{i,i}^{<}=g_{i,i}^{<}g_{i,i}^{R}Σₖ₌ᵢ₊₁ⁱ⁺¹⁺ⁿL_{i,k}^{T}G_{k,i}^{<}+Σₖ₌ᵢ₊₁ⁱ⁺¹⁺ⁿg_{i,k}^{<}Σₗ₌ᵢ₊₁ⁱ⁺¹⁺ⁿL_{k,l}⁵⁴⁴ G_{l,i}^{A}+Σₖ₌ᵢ₊₁ⁱ⁺¹⁺ⁿg_{i,k}^{R}Σₗ₌ₖ₊₁^{k+1+n} Σ_{k,l}^{<}G_{l,i}^{A} (34)

And with i<j

G_{i,j}^{<}=g_{i,j}^{<}g_{i,i}^{R}Σₖ₌ᵢ₊₁ⁱ⁺¹⁺ⁿL_{i,k}^{T}G_{k,j}^{<}+Σₖ₌ᵢ₋ₙ^{j}g_{i,k}^{<}Σₗ₌ᵢ₊₁^{j+1+n}L_{k,l}⁵⁴⁴ G_{l,i}^{A}+Σₖ₌ᵢ₋ₙⁱ⁺¹g_{i,k}^{R} Σₗ₌ⱼ₊₁^{j+1+n}Σ_{k,l}^{<}G_{l,i}^{A} (35)

Example 1: A software architecture includes a first protocol, wherein the first protocol is configured to discretize a many particle system into a first set of basis functions, thereby producing a discretized many particle system, wherein the first set of basis functions includes a plurality of basis functions. The software architecture additionally includes a second protocol, wherein the second protocol is configured to partition the discretized many particle system into a plurality of subsystems, wherein each subsystem of the plurality of subsystems is connected with at most two other subsystems of the plurality of subsystems, wherein each basis function of the plurality of basis functions correspond to a respective subsystem of the plurality of subsystems of the discretized many particle system. Further, the software architecture includes a third protocol, wherein the third protocol is configured to determine a second set of basis functions for each subsystem of the plurality of subsystems, wherein the second set of basis functions includes a plurality of functions, wherein each function of the plurality of functions describes an aspect of the many particle system, wherein the second set of basis functions is user defined. Additionally, the software architecture includes a fourth protocol, wherein the fourth protocol is configured to transform, for at least a subsystem of the plurality of subsystems, at least a portion of a discretized non-equilibrium Green's function method into the second set of basis functions, thereby producing a user-defined rank discretized nonequilibrium Green's function method.

Moreover, the software architecture includes a fifth protocol, wherein the fifth protocol is configured to solve the user-defined rank discretized non-equilibrium Green's function method with a generalized recursive Green's function method, thereby producing a plurality of Green's functions. The software architecture further includes a sixth protocol, wherein the sixth protocol is configured to transform at least a portion of the plurality of Green's functions into the first set of basis functions. Further, the software architecture includes a seventh protocol, wherein the seventh protocol is configured to extract a plurality of observables in the many particle system represented in the first set of basis functions by applying a respective operator on a corresponding Green's function of the plurality of Green's functions.

The aspect of the many particle system includes at least one of local properties of sections of the many particle system, local material properties of sections of the many particle system, quantum confinement of sections of the many particle system, quantum states of sections of the many particle system, charge density of sections of the many particle system, particle density of sections of the many particle system, heat density of sections of the many particle system, spin density of sections of the many particle system, color charge density of sections of the many particle system, chirality density of sections of the many particle system, current density of sections of the many particle system, particle current density of sections of the many particle system, heat current density of sections of the many particle system, spin current density of sections of the many particle system, chirality current density of sections of the many particle system, interaction strength of sections of the many particle system, or color current density of sections of the many particle system. The sections include an entirety of the many particle system.

The respective operator includes at least one of a density operator, a current density operator, a susceptibility operator, a polarization operator, a density of states operator, a position operator, a projection operator, or an integration operator.

The first protocol includes at least one of: a first procedure, wherein the first procedure is configured to use an envelope function approximation method; a second procedure, wherein the second procedure is configured to use an effective mass approximation method; a third procedure, wherein the third procedure is configured to use a k.p method; a fourth procedure, wherein the fourth procedure is configured to use an atomistic tight binding method; a fifth procedure, wherein the fifth procedure is configured to use a density functional theory method; a sixth procedure, wherein the sixth procedure is configured to use a finite differences discretization method; a seventh procedure, wherein the seventh procedure is configured to use a finite element method; an eighth procedure, wherein the eighth procedure is configured to use a cellular automata method; a ninth procedure, wherein the ninth procedure is configured to use a pseudo-potential method; a tenth procedure, wherein the tenth procedure is configured to use a molecular orbital method; an eleventh procedure, wherein the eleventh procedure is configured to use an atomic orbital method; or a twelfth procedure, wherein the twelfth procedure is configured to use a muffin-tin orbital method.

The many particle system of the software architecture includes at least one of electrons, photons, protons, spinons, skyrmions, polarons, polaritons, atoms, Cooper pairs, Bloch waves, magnons, plasmons, anyons, Fermions, Bosons, mesons, or Baryons.

The third protocol includes at least one of: a thirteenth procedure, wherein the thirteenth procedure is configured to use eigenfunctions of portions of the many particle system; a fourteenth procedure, wherein the fourteenth procedure is configured to use approximations to a band structure of portions of the many particle system; a fifteenth procedure, wherein the fifteenth procedure is configured to use a subset of the first set of basis functions; a sixteenth procedure, wherein the sixteenth procedure is configured to use Block functions of portions of the many particle system; a seventeenth procedure, wherein the seventeenth procedure is configured to use Wannier functions of portions of the many particle systems; an eighteenth procedure, wherein the eighteenth procedure is configured to use Wannier-Stark functions of portions of the many particle systems; or a nineteenth procedure, wherein the nineteenth procedure is configured to use Airy functions of portions of the many particle systems. The portions of the many particle system include at least one of a diagonal, a submatrix of a discretized many particle system, a set of sub-matrices of the discretized many particle system, or an approximate of the discretized many particle system.

The fourth protocol includes at least one of: a twentieth procedure, wherein the twentieth procedure is configured to transform the discretized non-equilibrium Green's function method into the second set of basis functions from the first set of basis functions; or a twenty-first procedure, wherein the twenty-first procedure is configured to transform an entirety of the discretized non-equilibrium Green's function method into the second set of basis functions.

The fifth protocol includes at least one of: a twenty-second procedure, wherein the twenty-second procedure is configured to use a recursive Green's function method; a twenty-third procedure, wherein the twenty-third procedure is configured to use a Keldysh method; a twenty-fourth procedure, wherein the twenty-fourth procedure is configured to use a Dyson method; a twenty-fifth procedure, wherein the twenty-fifth procedure is configured to use a LDL decomposition method; a twenty-sixth procedure, wherein the twenty-sixth procedure is configured to use a singular value decomposition method.

The sixth protocol includes at least one of: a twenty-seventh procedure, wherein the twenty-seventh procedure is configured to transform the discretized non-equilibrium Green's function method into the first set of basis functions from the second set of basis functions; or a twenty-eighth procedure, wherein the twenty-eighth procedure is configured to transform an entirety of the discretized non-equilibrium Green's function method into the first set of basis functions.

Example 2: In this example, impact of non-local polar optical phonon scattering (POP) is investigated through an atomistic simulation of III-V GaSb/InAs nanowire tunneling field effect transistor (TFET). Comparison of rigorous non-local scattering simulation against a simple local approximation and the newly developed physics-based scaling factor approach is performed. Impact of polar optical phonons on tunneling transport is investigated in detail.

Tunnel field-effect transistors (TFETs) are promising candidates to sustain the Moore's law scaling. Their ability to provide sub-60 mV/dec subthreshold slope offers possibilities to operate transistors at low voltages and perform low-power computation. A plethora of materials such as InGaAs, GaSb and InAs are considered as potential candidates as TFETs due to their direct band gap and lower effective masses which is important in the context of tunneling. Tunneling transistors provide sub-thermal switching by filtering out the high energy states in the Fermi distribution and by clever band engineering. Steep switching is achieved by a sudden onset of density of states through band alignment. Despite the ongoing research in TFETs, only a handful devices have managed to achieve sub-60 mV/dec SS. This is mainly due to imperfections in the device contributing to higher OFF current and SS. These imperfections include phonon scattering, alloy disorder, roughness, heavy doping induced band tail states and interface trap states which prevent sub-60 mV/dec SS performance.

On the other hand, simulation results have shown extremely positive results for several TFETs. Available ballistic NEGF approaches provide optimistic results with SS as low as 20 mV/dec being reported. Hence, there is a need to address this gap and provide quantitative and qualitative predictions that come close to experimental observations. Among the scattering mechanisms, polar optical phonon scattering (POP) is one of the dominant scattering mechanisms in the polar materials and is responsible for phonon assisted tunneling processes and formation of band tail states which are known to contribute to current. However, simulating TFETs with polar optical phonons has been a major challenge due to the non-locality of the scattering process. This non-locality increases the computational burden and often non-local scattering terms techniques are truncated while simulating POP scattering or an empirical scaling factor is used to account for the underestimation of scattering.

In this work, a physically consistent model to treat POP scattering with non-locality through self-energies has been developed and applied to a GaSb/InAs nanowire TFET. This method has been implemented within the multipurpose device simulator, NEMO5 and is available in multiple electronic models (e.g. effective mass, tight binding, Wannier function representations). Non-local scattering calculation is achieved through a recently developed non-local recursive Green's function approach which enables calculation of off-diagonal Green's function elements which is necessary for calculating non-local scattering contributions. A physics based scaling factor approach is developed that provides appropriate scaling factors to use while truncating the self-energy to usual local approximations so that the total impact of non-local scattering is captured. Using this approach, nanowire I-V results are compared against a simple ballistic approach and physical explanation for the behaviour is provided through current density plots which capture essential phonon assisted and band assisted tunneling process consistently.

Ultrascaled devices such as ultra-thin bodies and nanowires require atomistic resolution to capture essential physics. The device Hamiltonian is described in the empirical tight binding representation with a 10-band sp3d5s* tight binding model. Tight binding parameters for InAs are taken from and for GaSb are taken from. Device is simulated with NEGF using the non-local recursive Green's function approach (non-local RGF). In the usual recursive Green's function scheme, device is segmented into layers, and the diagonal blocks of the Green's functions, G^{R} and G^{<} are solved recursively. However, now we need to evaluate off-diagonal elements of self-energy as well. Hence, the non-local recursive Green's function approach is employed. An adaptive energy mesh is employed to resolve the band edges and density with finer resolution. Modeling TFETs involves inclusion of both valence and conduction band electron densities. However, due to the large energy window of the valence band, electrons and holes are modeled instead. This ensures that the energy range is limited to few k_{B}T above and below the Fermi window. Wherever there is a tunneling from a valence band state to a conduction band state, there is a transition of particles from holes to electrons and vice-versa. This transition is modeled by linearly interpolating the change in particle type. The spatial dependence of the conduction valence band edge is used to decide whether a particle is considered an electron or hole. In the transition region near the tunneling gap, a linear interpolated factor is used to smoothly transition between electrons and hole.

The NEGF equations with scattering self-energies involved solving the retarded and lesser Green's function as follows:

$$( E - H - {\sum }_{source}^{R} - {\sum }_{drain}^{R} - {\sum }_{\text{?}}^{R} ) {G}^{R} = I$$

$${G}^{<} = {G}^{R} ( {\sum }_{source}^{<} + {\sum }_{drain}^{<} + {\sum }_{\text{?}}^{<} ) {G}^{R †}$$

$$\text{?} \text{indicates text missing or illegible when filed}$$

Polar optical phonon scattering self-energies for nanowires are expressed as:

$${Σ}^{<} ( {{x}^{->}}_{1} , {{x}^{->}}_{2} , E ) = \frac{{e}^{2}}{{( 2 π )}^{3}} ( \frac{1}{\text{?}} - \frac{1}{\text{?}} ) \frac{h {ω}_{o}}{2 \text{?}} I ( {{x}^{->}}_{1} , {{x}^{->}}_{2} ) \times [ {n}_{o} {G}^{<} ( {{x}^{->}}_{1} , {{x}^{->}}_{2} , E - {E}_{o} ) + ( 1 + n \text{?} ) {G}^{<} ( {{x}^{->}}_{1} , {{x}^{->}}_{2} , E - E \text{?} ) ] \\ {Σ}^{R} ( {{x}^{->}}_{1} , {{x}^{->}}_{2} , E ) = \frac{{e}^{2}}{{( 2 π )}^{3}} ( \frac{1}{\text{?}} - \frac{1}{\text{?}} ) \frac{h {ω}_{o}}{2 \text{?}} I ( {{x}^{->}}_{1} , {{x}^{->}}_{2} ) \times [ ( 1 + {n}_{o} ) {G}^{R} ( {{x}^{->}}_{1} , {{x}^{->}}_{2} , E - {E}_{o} ) + {n}_{o} {G}^{R} ( {{x}^{->}}_{1} , {{x}^{->}}_{2} , E - {E}_{o} ) + \frac{1}{2} {G}^{<} ( {{x}^{->}}_{1} , {{x}^{->}}_{2} , E - {E}_{o} ) - \frac{1}{2} {G}^{<} ( {{x}^{->}}_{1} , {{x}^{->}}_{2} , E - {E}_{o} ) + i \int \frac{d \overline{E}}{2 π} {G}^{<} ( {{x}^{->}}_{1} , {{x}^{->}}_{2} , \overline{E} ) ( Pr \frac{1}{E - \overline{E} - {E}_{o}} - Pr \frac{1}{E - \overline{E} - {E}_{o}} ) ] \\ where \\ I ( {{x}^{->}}_{1} , {{x}^{->}}_{2} ) = \{ \begin{matrix}\frac{4 {π}^{2}}{a} [ \frac{1}{2 ( {{ζ}^{2} ( \frac{π}{a} )}^{2} + 1 )} - \frac{3 a}{2 ζ \text{?}} {tan}^{- 1} ( \frac{ζπ}{a} ) + 1 ] , \vert {{x}^{->}}_{1} - {{x}_{2}}^{->} \vert = 0 \\ \frac{{π}^{2}}{ζ} ( \frac{2 ζ}{\vert {{x}^{->}}_{1} - {{x}_{2}}^{->} \vert} - 1 ) {e}^{- \vert {{x}^{->}}_{1} - {{x}_{2}}^{->} \vert / ζ} \vert {{x}^{->}}_{1} - {{x}_{2}}^{->} \vert \neq 0\end{matrix} \\ \text{?} \text{indicates text missing or illegible when filed} \qquad ( 5.4 )$$

[symbol] ω [symbol] is the LO phonon frequency, [symbol] ₓ and [symbol] [symbol] correspond to the static and infinite frequency dielectric constants. n [symbol] is the Bose-Einstein distribution and ζ is the screening length. Screening length is calculated within the Lindhard formalism

$${ζ}_{Lindhard} = {( \frac{{e}^{2}}{\text{?}} \frac{- 2}{{( 2 π )}^{3}} \int d \overline{q} \frac{\partial f}{\partial t} \vert \text{?} )}^{- 1 / 2}$$

$$\text{?} \text{indicates text missing or illegible when filed}$$

where f is the Fermi distribution.

Solving a complete self-consistent simulation between transport involving self-consistent Born iterations and Poisson is challenging for in a multi-band basis due to the enormous computational load. To alleviate the problem, self-consistent Born iterations now involve solving off-diagonal elements of scattering self-energy which increase the computational load several orders even with the non-local recursive Green's function approach. Hence, the device is solved charge self-consistently with Poisson's equation and ballistic NEGF. The converged potentials are now imported into the transport solver and solved with non-local recursive Green's function with polar optical phonon scattering until current is uniform throughout the device. The potentials, in general vary with scattering but due to computational constraint the ballistic potential is assumed to represent the potential profile for scattering. Charge density and current are extracted as follows

$$n ( {x}^{->} ) = \int n ( {x}^{->} , E ) dE = \frac{1}{2 π} \int \text{?} ( diag ( tr ( {G}^{<} ( \overline{x} , \overline{x} , E ) ) ) dE \\ J \text{?} ( E ) = \frac{q}{h} \int \frac{dE}{2 π} \times 2 ℛ ( tr [ {H}_{i , i + 1} , {G}_{i + 1 , i}^{<} ( E ) ] ) \\ \text{?} \text{indicates text missing or illegible when filed}$$

Despite the ability to simulate off-diagonal elements of self-energy with non-local recursive Green's function approach, only a couple of off-diagonal elements can be calculated for a reasonable device in multi-band basis due to the enormous computational load. A compensation/scaling factor for the self-energies will be extremely useful in this regard where we can multiply the local self-energies (which are computatiaonally cheap) with the appropriate scaling factor to account for the effect of non-locality. Major requirement of the scaling factor should be that it's physics based and dependent on the confinement potential, bandstructure and energy. In this regard, a physics based scaling factor approach is developed to capture the effect of non-locality. Scaling factors are calculated based off of the Fermi's golden rule for the corresponding device under interest and the respective factor is multiplied with diagonal self-energy so that it mimics the actual non-local self-energy which is numerically challenging to solve for a realistic device.

The scaling factor is based on effective mass approach and assumes a parabolic dispersion but in principle, this approach can be applied to a general dispersion relation (which will be need for hole transport). Fermi's golden rule expression (absorption branch) for nanowires for polar optical phonon scattering can be written as:

$$\frac{1}{\text{?} ( E )} = \frac{{e}^{2} h {ω}_{LO} {N}_{p h}}{{h}^{2}} ( \frac{1}{\text{?}} - \frac{1}{\text{?}} ) \cdot \frac{2}{{( 2 π )}^{2}} \cdot \sqrt{2 {m}^{*}} ( \frac{{F}_{a} ( {k}_{x} - {k}_{x}^{′} ) + F \text{?} ( {k}_{z} + {k}_{z}^{′} )}{\sqrt{E - {E}_{j} + h {ω}_{LO}}} )$$

$$where F ( {q}_{x} ) = {\int }_{0}^{\text{?}} {\int }_{0}^{\text{?}} {\int }_{0}^{\text{?}} {\int }_{0}^{\text{?}} {dr}_{\vert \vert} {dr}_{\vert \vert}^{′} {ρ}_{ij}^{*} ( {r}_{\vert \vert} ) {ρ}_{ij} ( {r}_{\vert \vert}^{′} ) I ( {q}_{x} , {r}_{\vert \vert} , {r}_{\vert \vert}^{′} ) and$$

$$I ( q \text{?} , {r}_{\vert \vert} , {r}_{\vert \vert}^{′} ) = \{ \begin{matrix}( \sqrt{{q}_{x}^{2} + {ζ}^{- 2}} \vert {r}_{\vert \vert} - {r}_{\vert \vert}^{′} \vert + \frac{q \text{?} \vert {r}_{\vert \vert} - {r}_{\vert \vert}^{′} \vert}{\sqrt{q \text{?} + {ζ}^{- 2}}} ) \frac{{K}_{1} ( \sqrt{q \text{?} + {ζ}^{- 2}} \vert {r}_{\vert \vert} - {r}_{\vert \vert}^{′} \vert )}{2} , \\ \vert {r}_{\vert \vert} - {r}_{\vert \vert}^{′} \vert \neq 0 \\ ( \frac{1}{2} + \frac{q \text{?}}{2 ( q \text{?} + {ζ}^{- 2} )} ) , \vert {r}_{\vert \vert} - {r}_{\vert \vert}^{′} \vert = 0\end{matrix} \\ and {ρ}_{ij} ( {r}_{\vert \vert} ) = {ψ}_{i}^{*} ( {r}_{\vert \vert} ) {ψ}_{j} ( {r}_{\vert \vert} ) \\ \text{?} \text{indicates text missing or illegible when filed}$$

From the equations above, one can observe that the scattering kernel is dependent on the non-local distance. The scattering kernel, in turn is integrated along with the squared of the wavefuctions to get the corresponding rate for a particular momentum and screening length. An equivalent expression for the local case would only correspond to truncating terms other than the diagonal in the scattering kernel. The local version of scattering kernels for nanowires can be written as follows:

$${I}_{Local} ( q \text{?} , {r}_{\vert \vert} , {r}_{\vert \vert}^{′} ) = \{ \begin{matrix}( \frac{1}{2} + \frac{{q}_{x}^{2}}{2 ( {q}_{x}^{2} + {ζ}^{- 2} )} ) , \vert {r}_{\vert \vert} - {r}_{\vert \vert}^{′} \vert = 0 \\ 0 , \vert {r}_{\vert \vert} - {r}_{\vert \vert}^{′} \vert \neq 0\end{matrix} \\ \text{?} \text{indicates text missing or illegible when filed}$$

The scaling factor is now just a division of form factors for the local case with the nonlocal one. In effective mass basis, the factor as such does not have an explicit effective mass dependence (implicitly through energy-momentum relation) and depends significantly on the spatial nature of modes, dimension of the device and screening length. The scaling factor can now be represented as:

$$S \text{?} = \frac{{\int }_{0}^{\text{?}} {\int }_{0}^{\text{?}} {\int }_{0}^{\text{?}} {\int }_{0}^{\text{?}} {dr}_{\vert \vert} {dr}_{\vert \vert}^{′} {ρ}_{ij}^{*} ( {r}_{\vert \vert} ) {ρ}_{ij} ( {r}_{\vert \vert}^{′} ) I ( {q}_{x} , {r}_{\vert \vert} , {r}_{\vert \vert}^{′} )}{{\int }_{0}^{\text{?}} {\int }_{0}^{\text{?}} {\int }_{0}^{\text{?}} {\int }_{0}^{\text{?}} {dr}_{\vert \vert} {dr}_{\vert \vert}^{′} {ρ}_{ij}^{*} ( {r}_{\vert \vert} ) {ρ}_{ij} ( {r}_{\vert \vert}^{′} ) {I}_{Local} ( {q}_{x} , {r}_{\vert \vert} , {r}_{\vert \vert}^{′} )}$$

$$\text{?} \text{indicates text missing or illegible when filed}$$

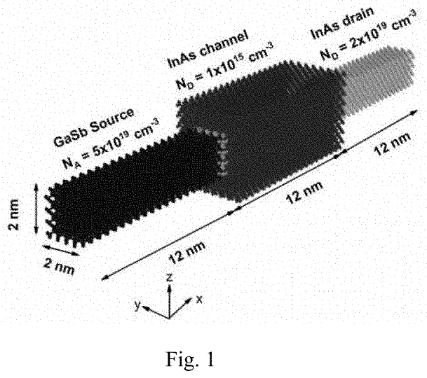

FIG. 1 illustrates the GaSb/InAs TFET considered in this study. Device considered is a 2×2 nm² nanowire with a device length of 36 nm. Source region is 12 nm long and is p-doped GaSb with a doping concentration of 5×10¹⁹ cm⁻³. Channel region is 12 nm long and is taken to be intrinsic InAs. Drain region is 12 nm long as well and is n-doped InAs with a doping concentration of 2×10¹⁹ cm⁻³. Intrinsic region is surrounded by gate oxide 1 nm thick with a dielectric constant of 20. Oxide region is considered only in the Poisson's equation and is not part of transport. Phonon scattering parameters are averaged across InAs and GaSb parameters and remains constant throughout the device. LO phonon energy is taken to be 30 meV, static and infinite frequency dielectric constants are taken to be 15.42 and 13.35. These material parameters have been taken from. Screening length is set to 3 nm. POP scattering simulations are performed both with simple local approximation where the off-diagonal terms are truncated to zero and by actually including off-diagonal elements upto a non-local range of 0.3 nm (1st offdiagonal) to cover non-local scattering. Subsequently, the scaling factor procedure described above is used to multiply the local self-energy with an appropriate scaling factor for the given non-local range to account for the underestimation of scattering. Based on the calculations, the scaling factor is estimated to be 5 for a non-local range of 0.3 nm (energy averaged).

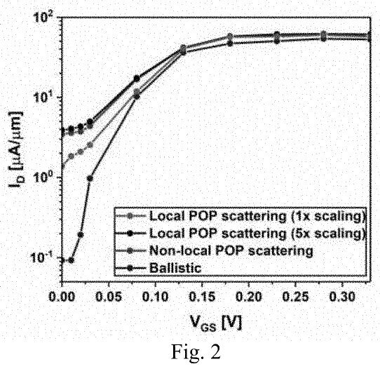

Simulations results with nanowire TFET are discussed in this section. FIG. 2 shows the I-V characteristics of the GaSb/InAs TFET over the voltage range 0-0.35V. There are several important observations that one can make from this figure. Ballistic simulation of TFET provides a very good ON-OFF ration (approximately 10³) resulting in a steep switching of transistor. This happens in a voltage range of about 50 mV which corresponds to the transition point where the conduction band profile of the channel meets the valence band edge of the source. However, POP scattering with a simple local approximation where the off-diagonals are truncated to zero shows an immediate jump in OFF current. Also, the transition is not as steep as the ballistic case highlighting the impact of phonon scattering in tunneling process. Non-local POP scattering increases the OFF current floor further due to additional elements of the self-energy contributing to the scattering process. Local POP scattering with scaling factor of 5× increases the current as expected due to strong phonon scattering. It is interesting to note that the predicted scaling factor of 5× from Fermi's golden rule agrees quite well with the complete non-local simulation providing confidence in the scaling factor extraction approach.

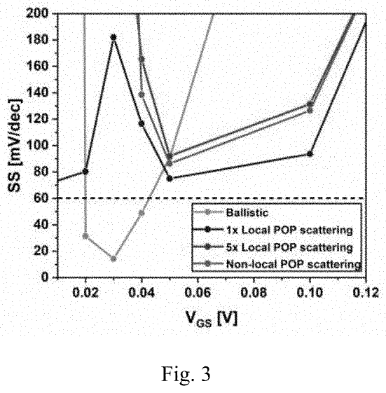

FIG. 3 illustrates the subthreshold slope as a function of VGS for all the simulation cases discussed above. Ballistic simulation shows an optimistic SS of 16 mV/dec due to a sharp transition between the ON-OFF state. However, with the addition of scattering, the SS is raised above the thermal limit and the device no longer offers subthreshold slope <60 mV/dec. Increasing the non-locality of scattering further enhances the SS making it a poor switching device.

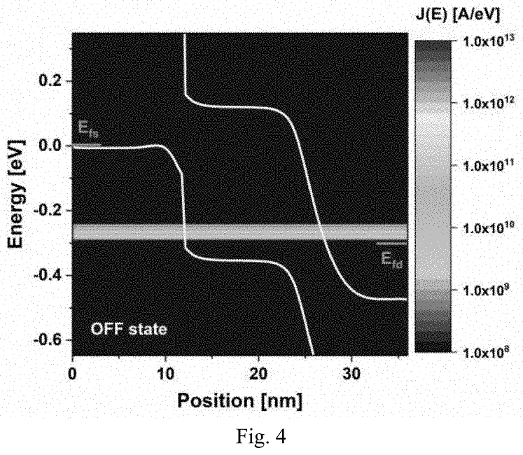

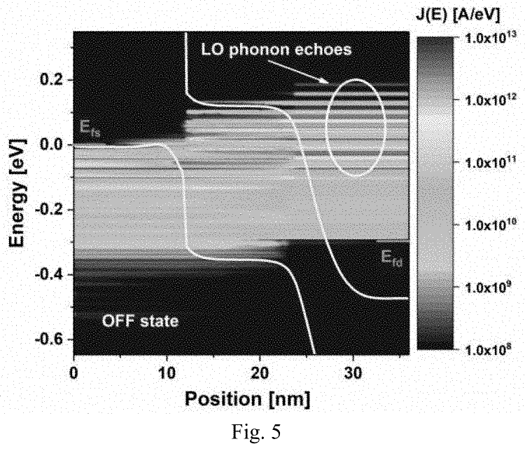

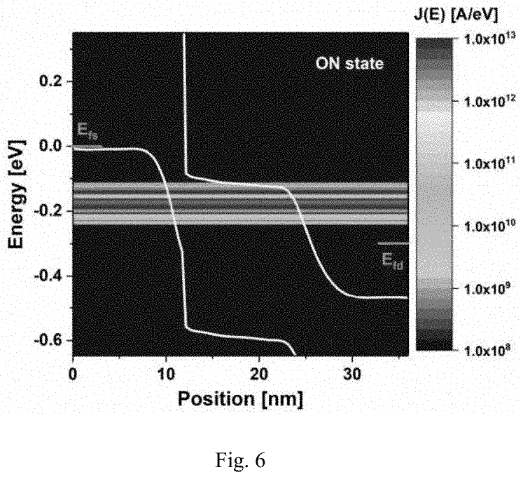

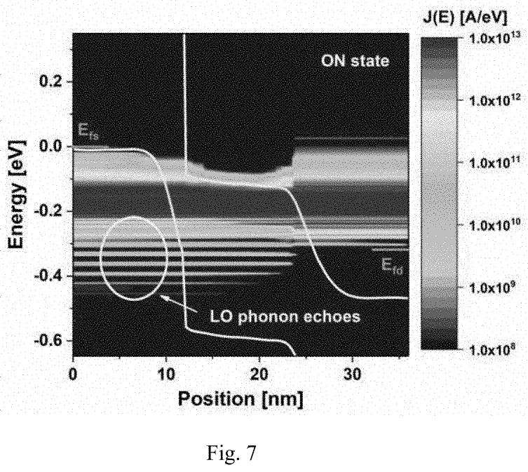

A detailed physical picture behind the transport process can be observed by looking at the energy resolved current density across the device as shown in FIGS. 4 and 5 for the OFF state and FIGS. 6 and 7 for the ON state of the device. OFF state ballistic profile has a low current density due to the large tunneling distance and has a peak only in the transmission energy window. However, the moment scattering is turned on, the current density is no longer restricted to the ballistic energy profile and is smeared out throughout the Fermi window. There are several interesting features in the OFF state. Firstly, the current density in general is higher than the ballistic case due to phonon assisted tunneling processes. Secondly, there are several sharp density channels separated by LO phonon energies. At energy range [−0.2,0.0] eV on the source side, there are several peaks that correspond to phonon emission processes. There is significant tunneling in the channel region with electrons tunneling by absorbing LO phonons and propagating to the drain side. This increases both the OFF current and also results in a higher SS since the device no longer has a energy barrier window where transmission can be prevented. Transmission can now occur in this energy barrier window through phonon assisted tunneling processes.

The ON state, on the other hand, does have distinguishing features between the ballistic and scattered case but is not as dramatic as the OFF state. In the ON state, since the transmission in general is higher due to the smaller tunneling energy and distance, current density is high in both ballistic and scattered case. However, some additional channels are created with phonon abosrption process on the source side which provides tunneling windows that decays down rapidly with energy ([−0.4, −0.2] eV energy range). The rapid decay of the LO phonon echoes is due to vanishing Fermi distribution function which decays rapidly beyond the Fermi energy window. This results in current densities being similar in the ON state with the phonon scattering current slightly higher than the ballistic case.

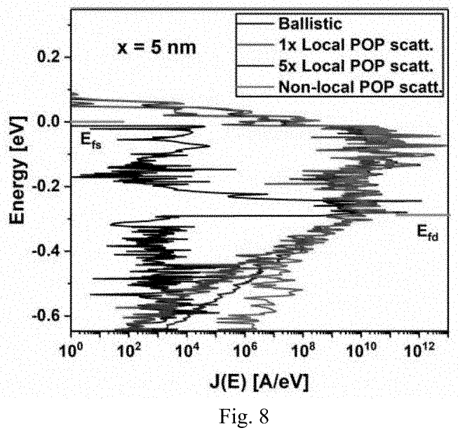

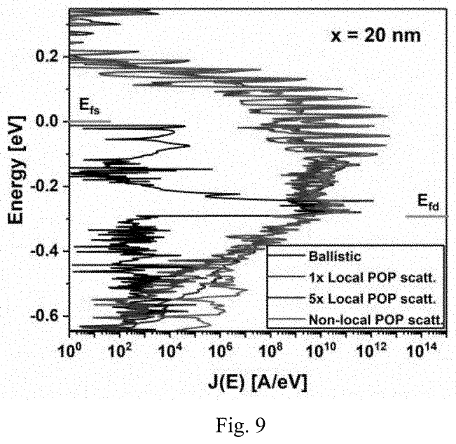

Impact of phonon scattering and it's non-locality can be observed by taking cross section cuts of energy resolved current density J(E) at various points. FIGS. 8 and 9 show the cross section cuts of the current density at x=5 nm (p-doped GaSb region) and x=20 nm (tunneling region). In the p-doped GaSb region, one can clearly observe the narrow region in which ballistic transmission occurs and the current density drops by 6 orders of magnitude in the region outside the window. However, with phonon scattering, energy values higher than the window are enhanced due to decreasing tunneling window and phonon assisted tunneling process. Once the bandedge is reached, transport does not stop abruptly (as one would expect in a ballistic transport situation) but decreases exponentially with echoes separated apart by LO phonon energy. These echoes are generated by exponentially decaying band tail states present above the valence band edge. These band tail states are generated by inelastic multi-phonon emission processes that are automatically captured in the self-consistent Born picture in NEGF. Also, the scaling factor approach captures not only the non-local scattering current accurately but also the density profile as seen in FIG. 8. There is deviation at higher energies where the scaling rule fails but the important energies are captured accurately.

In the intrinsic region (FIG. 9), one can observe that the current density has very well defined peak states that are separated by LO phonon energies. This effect can only be captured by a true inelastic scattering process where these interesting features are exhibited. These channels of current density correspond to electrons tunneling across the junctions aided by a phonon emission/absorption process and similar to the current density in the p-doped region, they decay down gradually due to exponentially decaying band tail states. The simulation can capture both phonon assisted and band tail assisted tunneling quite well and provides an intuitive explanation behind the observed I-V profile with scattering.

An atomistic simulation of III-V GaSb/InAs nanowire TFET is performed with nonlocal polar optical phonon scattering and the impact of scattering is assessed. Device is simulated with NEGF approach with scattering included within the self-consistent Born iteration scheme. A scaling factor methodology is developed to provide physics based scaling factors for non-local scattering using Fermi's golden rule. Scattering self-energy is solved using 3 different scenarios—local approximation with truncation of non-local terms, local approximation with scaling factor and non-local scattering with a finite nonlocal range. I-V characteristics for all the cases are compared and scattering is shown to increase both OFF current floor and SS due to enhanced tunneling from phonon assisted and band tail assisted tunneling. Detailed tunneling process is analyzed by looking at the energy resolved current density profile of the device. Scaling factor is shown to capture the actual non-local scattering quite accurately.

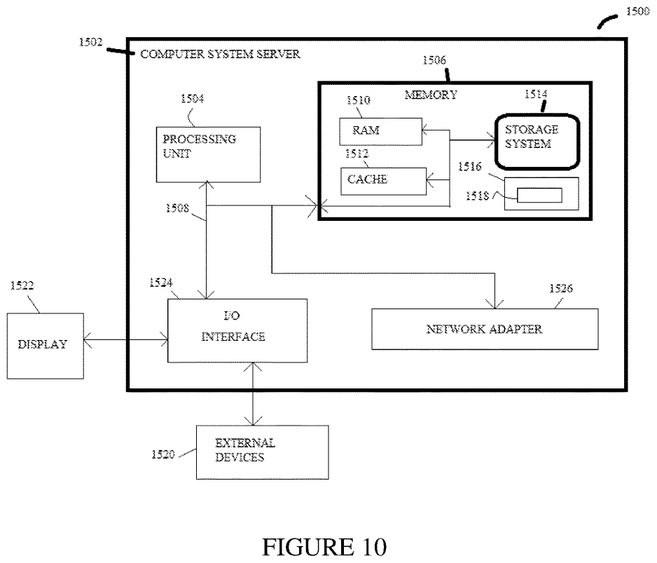

FIG. 10 illustrates one example of a computing or processing node 1500 for operating the methods and the software architecture of the present application. This is not intended to suggest any limitation as to the scope of use or functionality of embodiments of the invention described herein. Regardless, the computing node 1500 is capable of being implemented and/or performing any of the functionality set forth hereinabove.

In computing node 1500 there is a computer system/server 1502, which is operational with numerous other general purpose or special purpose computing system environments or configurations. Examples of well-known computing systems, environments, and/or configurations that may be suitable for use with computer system/server 1502 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 1502 may be described in the general context of computer system executable instructions, such as program modules, being executed by a computer system. Generally, program modules may include routines, programs, objects, components, logic, data structures, and so on that perform particular tasks or implement particular abstract data types. Computer system/server 502 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 10, computer system/server 1502 in cloud computing node 1500 is shown in the form of a general-purpose computing device. The components of computer system/server 1502 may include, but are not limited to, one or more processors or processing units 1504, a system memory 1506, and a bus 1508 that couples various system components including system memory 1506 to processor 1504.

Bus 1508 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 1502 typically includes a variety of computer system readable media. Such media may be any available media that is accessible by computer system/server 1502, and it includes both volatile and non-volatile media, removable and non-removable media.

System memory 1506, in one embodiment, implements the methods and the software architectures of the present application. The system memory 506 can include computer system readable media in the form of volatile memory, such as random access memory (RAM) 1510 and/or cache memory 1512. Computer system/server 1502 may further include other removable/non-removable, volatile/non-volatile computer system storage media. By way of example only, storage system 1514 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1508 by one or more data media interfaces. As will be further depicted and described below, memory 1506 may include at least one program product having a set (e.g., at least one) of program modules that are configured to carry out the functions of various embodiments of the invention.

Program/utility 1516, having a set (at least one) of program modules 1518, may be stored in memory 1506 by way of example, and not limitation, as well as an operating system, one or more application programs, other program modules, and program data. Each of the operating system, one or more application programs, other program modules, and program data or some combination thereof, may include an implementation of a networking environment. Program modules 1518 generally carry out the functions and/or methodologies of various embodiments of the invention as described herein.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Computer system/server 1502 may also communicate with one or more external devices 1520 such as a keyboard, a pointing device, a display 1522, etc.; one or more devices that enable a user to interact with computer system/server 1502; and/or any devices (e.g., network card, modem, etc.) that enable computer system/server 1502 to communicate with one or more other computing devices. Such communication can occur via I/O interfaces 1524. Still yet, computer system/server 1502 can communicate with one or more networks such as a local area network (LAN), a general wide area network (WAN), and/or a public network (e.g., the Internet) via network adapter 1526. As depicted, network adapter 1526 communicates with the other components of computer system/server 1502 via bus 1508. It should be understood that although not shown, other hardware and/or software components could be used in conjunction with computer system/server 1502. Examples, include, but are not limited to: microcode, device drivers, redundant processing units, external disk drive arrays, RAID systems, tape drives, and data archival storage systems, etc.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, design, machine, manufacture, and composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

1. A non-transitory machine readable storage medium having a machine readable program stored therein, wherein the machine readable program, when executed on a processing system, causes the processing system to perform a procedure of modeling many particle systems, wherein the procedure comprises:
discretizing a many particle system into a first set of basis functions, thereby producing a discretized many particle system, wherein the first set of basis functions comprises a plurality of basis functions;
partitioning the discretized many particle system into a plurality of subsystems, wherein each subsystem of the plurality of subsystems is connected with at most two other subsystems of the plurality of subsystems, wherein each basis function of the plurality of basis functions correspond to a respective subsystem of the plurality of subsystems of the discretized many particle system;
determining a second set of basis functions for each subsystem of the plurality of subsystems, wherein the second set of basis functions comprises a plurality of functions, wherein each function of the plurality of functions describes an aspect of the many particle system, wherein the second set of basis functions is user defined;
transforming, for at least a subsystem of the plurality of subsystems, at least a portion of a discretized non-equilibrium Green's function method into the second set of basis functions, thereby producing a user-defined rank discretized nonequilibrium Green's function method;
solving the user-defined rank discretized non-equilibrium Green's function method with a generalized recursive Green's function method, thereby producing a plurality of Green's functions;
transforming at least a portion of the plurality of Green's functions into the first set of basis functions; and
extracting a plurality of observables in the many particle system represented in the first set of basis functions by applying a respective operator on a corresponding Green's function of the plurality of Green's functions.

2. The procedure of claim 1, wherein the discretizing the many particle system into the first set of basis functions comprises at least one of:
using an envelope function approximation method;
using an effective mass approximation method;
using a k.p method;
using an atomistic tight binding method;
using a density functional theory method;
using a finite differences discretization method;
using a finite element method;
using a cellular automata method;
using a pseudo-potential method;
using a molecular orbital method;
using an atomic orbital method; or
using a muffin-tin orbital method.

3. The procedure of claim 1, wherein the many particle system comprises at least one of electrons, photons, protons, spinons, skyrmions, polarons, polaritons, atoms, Cooper pairs, Bloch waves, magnons, plasmons, anyons, Fermions, Bosons, mesons, or Baryons.

4. The procedure of claim 1, wherein the determining a second set of basis functions comprises at least one of:
using eigenfunctions of portions of the many particle system;
using approximations to a band structure of portions of the many particle system;
using a subset of the first set of basis functions;
using Bloch functions of portions of the many particle system;
using Wannier functions of portions of the many particle systems;
using Wannier-Stark functions of portions of the many particle systems; or
using Airy functions of portions of the many particle systems.

5. The procedure of claim 4, wherein the portions comprise at least one of a diagonal, a submatrix of a discretized many particle system, a set of sub-matrices of the discretized many particle system, or an approximate of the discretized many particle system.

6. The procedure of claim 1, wherein the aspect comprises at least one of local properties of sections of the many particle system, local material properties of sections of the many particle system, quantum confinement of sections of the many particle system, quantum states of sections of the many particle system, charge density of sections of the many particle system, particle density of sections of the many particle system, heat density of sections of the many particle system, spin density of sections of the many particle system, color charge density of sections of the many particle system, chirality density of sections of the many particle system, current density of sections of the many particle system, particle current density of sections of the many particle system, heat current density of sections of the many particle system, spin current density of sections of the many particle system, chirality current density of sections of the many particle system, interaction strength of sections of the many particle system, or color current density of sections of the many particle system.

7. The procedure of claim 6, wherein the sections comprises an entirety of the many particle system.

8. The procedure of claim 1, wherein the transforming at least the portion of the discretized non-equilibrium Green's function method into the second set of basis functions comprises at least one of:
transforming the discretized non-equilibrium Green's function method into the second set of basis functions from the first set of basis functions; or
transforming an entirety of the discretized non-equilibrium Green's function method into the second set of basis functions.

9. The procedure of claim 1, wherein the solving comprises at least one of:
using a recursive Green's function method;
using a Keldysh method;
using a Dyson method;
using a LDL decomposition method; or
using a singular value decomposition method.

10. The procedure of claim 1, wherein the transforming at least the portion of the plurality of Green's functions into the first set of basis functions comprises at least one of:
transforming the discretized non-equilibrium Green's function method into the first set of basis functions from the second set of basis functions; or
transforming an entirety of the discretized non-equilibrium Green's function method into the first set of basis functions.

11. The procedure of claim 1, wherein the respective operator comprises at least one of a density operator, a current density operator, a susceptibility operator, a polarization operator, a density of states operator, a position operator, a projection operator, or an integration operator.
